(19) United States
(12) Patent Application Publication
(10) Pub. No.: US 2024/0196161 A1
(43) Pub. Date: Jun. 13, 2024

(54) SYSTEMS AND METHODS OF USING WIRELESS SIGNATURES

(71) Applicant: Meta Platforms Technologies, LLC, Menlo Park, CA (US)

(72) Inventor: Siddharth Ray, Cupertino, CA (US)

(21) Appl. No.: 18/077,786

(22) Filed: Dec. 8, 2022

(51) Int. Cl. H04W 4/021; G06T 11/00

(52) U.S. Cl. CPC H04W 4/021; G06T 11/00

(57) ABSTRACT

Disclosed herein are systems and methods for utilizing wireless signature (e.g., wireless fingerprint) data for improved simultaneous localization and mapping (SLAM) in AR object rendering applications. The solution can include a device with at least one processor configured to establish a wireless signature for a location of the device. The wireless signature can represent unique identifiers of wireless communication devices and distance indicators of the wireless communication devices relative to the device. The processor can be configured to identify one or more augmented reality maps from a plurality of augmented reality maps according to the wireless signature. The processor can be configured to identify a first augmented reality map of the one or more augmented reality maps associated with the location of the device to render an artificial reality object corresponding to the first augmented reality map.

### FIELD OF DISCLOSURE

The present disclosure is generally related to providing extended reality (XR) content, including but not limited to simultaneous localization and mapping (SLAM) in AR applications.

### BACKGROUND

Extended or Artificial reality, such as virtual reality (VR), augmented reality (AR), or mixed reality (MR), can provide a user with an immersive experience in which the user wearing a head wearable display (HWD) can see virtual objects, provided by the HWD, in particular locations in which they are rendered by the HWD. Such artificial objects can be immersed, displayed, or otherwise provided along with one or more real objects or artificial objects. The user's HWD can utilize sensors to detect the user's location and/or orientation of the HWD in order to display to the user various AR content.

### SUMMARY

When generating data to display in a HWD of a user, maps (e.g., extended/augmented/virtual reality maps) of locations may be recovered in order to support/create an AR rendering of an object in a particular location. However, recovering the relevant maps based on global positioning data (GPS), such as latitude, longitude and altitude data, can be challenging. As map identification using GPS data can have limited accuracy, this approach can result in an excessive number of maps being identified for processing, thereby straining the resources and/or bandwidth. The present solution provides a more accurate and efficient way to identify and recover the relevant maps to use for AR/VR rendering, by employing wireless signature or fingerprint data to identify each map based on both unique identifiers of the local wireless communication devices at the locations being mapped as well as unique indications of the distances between each of the locations and each such uniquely identified wireless communication devices. The resulting wireless signature or fingerprint can help narrow down the scope of relevant maps to identify, recover/access and process for AR object rendering, thereby improving the accuracy while also reducing the use of resources and bandwidth in the SLAM applications.

In some aspects, the present solution relates to a method. The method can include establishing, by a device, a wireless signature for a location of the device. The wireless signature can represent one or more unique identifiers of one or more wireless communication devices. The wireless signature can represent one or more distance indicators of the one or more wireless communication devices relative to the device. The method can include the device identifying one or more augmented reality maps from a plurality of augmented reality maps according to the wireless signature. The method can include the device identifying a first augmented reality map of the one or more augmented reality maps associated with the location of the device, to render an augmented reality object corresponding to the first augmented reality map.

The one or more wireless communication devices can include a plurality of wireless communication devices configured to communicate according to one or more wireless communication protocols. Each of the one or more wireless communication devices can be configured to communicate according to at least one of: a Bluetooth-based communication protocol, a wireless local area network (WLAN) communication protocol or a cellular communication protocol.

The method can include the device determining a first distance indicator of the one or more distance indicators, between the device and a first wireless communication device of the one or more wireless communication devices, according to a plurality of measurements of signals from the first wireless communication device performed by the device over a period of time. The method can include identifying, by the device using the wireless signature of the location of the device, the one or more augmented reality maps from a plurality of augmented reality maps. The plurality of augmented reality maps can each be associated with at least one wireless signature.

The method can include identifying, by the device, the one or more augmented reality maps from a subset of the plurality of augmented reality maps. The subset of the plurality of augmented reality maps can be identified using at least one of latitude information, longitude information or altitude information of the device. The method can include generating, by the device at a first location, a first augmented reality map and a first wireless signature corresponding to the first augmented reality map. The method can include providing, by the device to a storage, at least one of: the first augmented reality map, the first wireless signature, or positioning information of the device at the first location, for storage.

In some aspects, the present solution can relate to a system. The system can include a device including at least one processor configured to establish a wireless signature for a location of the device. The wireless signature can represent one or more unique identifiers of one or more wireless communication devices and one or more distance indicators of the one or more wireless communication devices relative to the device. The processor can be configured to identify one or more augmented reality maps from a plurality of augmented reality maps according to the wireless signature. The processor can be configured to identify a first augmented reality map of the one or more augmented reality maps associated with the location of the device to render an augmented reality object corresponding to the first augmented reality map.

The one or more wireless communication devices can include a plurality of wireless communication devices configured to communicate according to one or more wireless communication protocols. The one or more wireless communication devices can be configured to communicate according to at least one of: a Bluetooth-based communication protocol, a wireless local area network (WLAN) communication protocol or a cellular communication protocol. The device can be further configured to determine a first distance indicator of the one or more distance indicators between the device and a first wireless communication device of the one or more wireless communication devices according to a plurality of measurements of signals from the first wireless communication device performed by the device over a period of time.

The system can include the device configured to identify using the wireless signature of the location of the device, the one or more augmented reality maps from a plurality of augmented reality maps. The plurality of augmented reality maps can each be associated with at least one wireless signature. The device can be configured to identify the one or more augmented reality maps from a subset of a plurality of augmented reality maps. The subset of the plurality of augmented reality maps can be identified using at least one of: latitude information, longitude information or altitude information of the device. The device can be configured to generate at a first location a first augmented reality map and a first wireless signature corresponding to the first augmented reality map. The device can be configured to provide, to a storage, at least one of: the first augmented reality map, the first wireless signature or positioning information of the device at the first location, for storage.

In some aspects, the present solution can relate to a non-transitory computer readable medium storing program instructions. The program instructions can cause at least one processor of a device to establish a wireless signature for a location of the device. The wireless signature can represent one or more unique identifiers of one or more wireless communication devices and one or more distance indicators of the one or more wireless communication devices relative to the device. The program instructions can cause the at least one processor to identify one or more augmented reality maps from a plurality of augmented reality maps according to the wireless signature. The program instructions can cause the at least one processor to identify a first augmented reality map of the one or more augmented reality maps associated with the location of the device, to render an augmented reality object corresponding to the first augmented reality map.

Each of the one or more wireless communication devices can be configured to communicate according to at least one of: a Bluetooth-based communication protocol, a wireless local area network (WLAN) communication protocol or a cellular communication protocol. The program instructions cause the at least one processor to determine a first distance indicator of the one or more distance indicators between the device and a first wireless communication device of the one or more wireless communication devices according to a plurality of measurements of signals from the first wireless communication device performed by the device over a period of time.

The program instructions can cause the at least one processor to identify using the wireless signature of the location of the device the one or more augmented reality maps from a plurality of augmented reality maps, the plurality of augmented reality maps each associated with at least one wireless signature. The program instructions can cause the at least one processor to identify the one or more augmented reality maps from a subset of the plurality of augmented reality maps. The subset of the plurality of augmented reality maps can be identified using at least one of latitude information, longitude information or altitude information of the device. The program instructions can cause the at least one processor to generate at a first location a first augmented reality map and a first wireless signature corresponding to the new augmented reality map. The program instructions can cause the at least one processor to provide, to a storage, at least one of: the first augmented reality map, the first wireless signature, or positioning information of the device at the first location, for storage.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an extended reality system, according to an example implementation of the present disclosure.

FIG. 2 is a diagram of a head wearable display, according to an example implementation of the present disclosure.

FIG. 3 is a diagram of an example of a system for localization and mapping of AR objects using wireless signatures, according to an example implementation of the present disclosure.

FIG. 4 is a diagram of an example of a system for generating and storing maps with wireless signatures, according to an example implementation of the present disclosure.

FIG. 5 is a flowchart showing a process of localization and mapping of an AR object using a wireless signature, according to an example implementation of the present disclosure.

FIG. 6 is another flowchart showing a process of localization and mapping of an AR object using a wireless signature, according to an example implementation of the present disclosure.

FIG. 7 is a flowchart showing a process of generating maps with wireless signatures, according to an example implementation of the present disclosure.

FIG. 8 is a block diagram of a computing system or an environment according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

The present disclosure is directed to systems and methods for utilizing wireless signature (e.g., wireless fingerprint) data for improved simultaneous localization and mapping (SLAM) in AR object rendering applications. When implementing an AR rendering of an object in a view of a HWD of a user, maps of areas in which to present the rendered object can be identified using the GPS latitude, longitude and altitude data. However, GPS data is limited in accuracy and spatial range of images it can identify, resulting in an excessive amount of (surplus) maps selected for processing. This surplus (that can include non-relevant maps) can strain the resources and bandwidth of the system, limiting the system's ability to correctly and consistently identify the intended maps for AR rendering and adversely affecting the user experience.

The present solution relies on wireless signatures (e.g., wireless fingerprint) of mapped locations to accurately identify only those maps that are relevant for efficient AR rendering, thereby improving the system's consistency and user experience while also conserving the processing resources and the bandwidth. The wireless signature can include unique identifiers of any wireless communication devices at the mapped location along with indicators of distances between the given map locations and each of the identified wireless communication devices. As a result, the wireless signature can provide a more efficient and more accurate description of the specific location for which the maps are being recovered, resulting in the recovery of a smaller subset of maps than is the case when relying on the less accurate GPS data alone.

In one example, the present solution can include a storage with maps that are coded with (or indexed/arranged according to) wireless signature data, along with any other map-related data, such as image details or GPS data. When a user's HWD seeks to identify maps for (re)constructing/recovering an AR space in which to render an AR object, the present solution can utilize the wireless signature (e.g., wireless fingerprint) to more accurately and efficiently identify the specific subset of maps to be processed for creating an AR environment around the relevant location of the AR object. Once the specific subset of maps is identified, the present solution can implement the visual search function to render the AR object at the specific location with a greater precision and improved user experience, while also reducing the burden on the bandwidth and the resources.

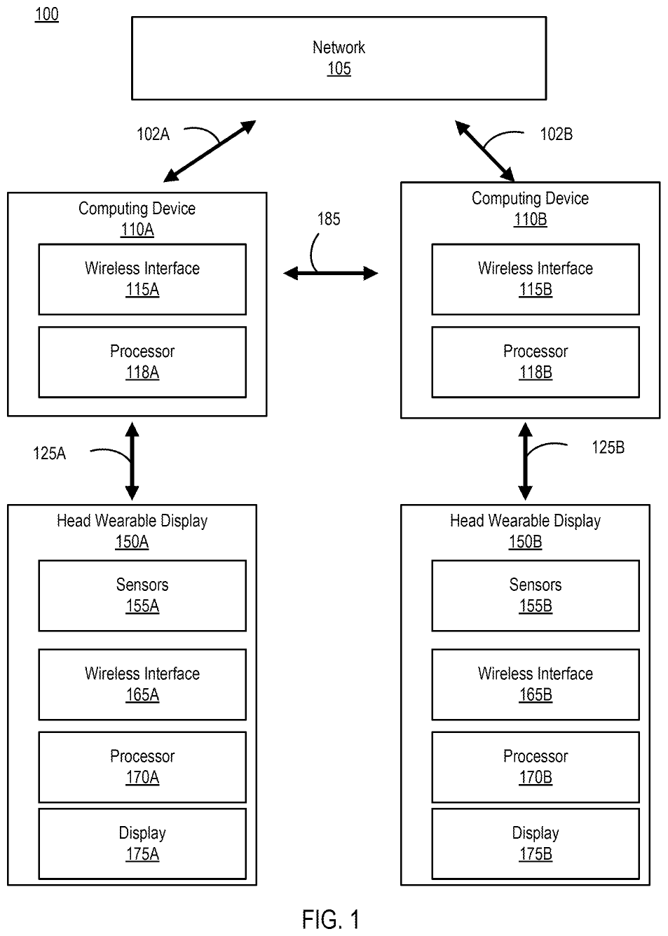

FIG. 1 is a block diagram of an example artificial reality (e.g., extended reality) system environment 100. In some embodiments, the artificial reality system environment 100 includes a network 105, one or more HWDs 150 (e.g., HWD 150A, 150B), and one or more computing devices 110 (computing devices 110A, 110B) providing data for artificial reality to the one or more HWDs 150. The network 105 may be a router or any network device allowing one or more computing devices 110 and/or one or more HWDs 150 to access a network (e.g., the Internet). The network 105 may be replaced by any communication device (cell site). A computing device 110 may be a computing device or a mobile device that can retrieve content from the network 105, and can provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the network 105 through wireless links 102A, 102B (e.g., interlinks), respectively. In some embodiments, the computing device 110A communicates with the HWD 150A through a wireless link 125A (e.g., intralink), and the computing device 110B communicates with the HWD 150B through a wireless link 125B (e.g., intralink). In some embodiments, functionality of one or more components of the artificial reality system environment 100 can be distributed among the components in a different manner than is described here. For example, some of the functionality of the computing device 110 may be performed by the HWD 150. For example, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD) or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink). The wireless interface 165 may also communicate with the network 105 through a wireless link (e.g., interlink). Examples of the wireless link 125 include a near field communication link, Wi-Fi direct, Bluetooth, or any wireless communication link. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered, and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, reprojection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. The computing device 110 may also communicate with the network 105, and may obtain AR/VR content from the network 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink). In other embodiments, the computing device 110 includes more, fewer, or different components than shown in FIG. 1.

In some embodiments, the wireless interface 115 is an electronic component or a combination of an electronic component and a software component that communicates with the HWD 150, the network 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink). The wireless interface 115 may also include a component to communicate with the network 105 through a wireless link 102 (e.g., interlink). Examples of wireless link 102 include a cellular communication link, a near field communication link, Wi-Fi, Bluetooth, 60 GHz wireless link, or any wireless communication link. The wireless interface 115 may also include a component to communicate with a different computing device 110 through a wireless link 185. Examples of the wireless link 185 include a near field communication link, Wi-Fi direct, Bluetooth, or any wireless communication link. Through the wireless link 102 (e.g., interlink), the wireless interface 115 may obtain AR/VR content, or other content from the network 105. Through the wireless link 125 (e.g., intralink), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

In some embodiments, the processors 118, 170 may configure or cause the wireless interfaces 115, 165 to toggle, transition, cycle or switch between a sleep mode and a wake up mode. In the wake up mode, the processor 118 may enable the wireless interface 115 and the processor 170 may enable the wireless interface 165, such that the wireless interfaces 115, 165 may exchange data. In the sleep mode, the processor 118 may disable the wireless interface 115 and the processor 170 may disable (e.g., may implement low power or reduced operation in) the wireless interface 165, such that the wireless interfaces 115, 165 may not consume power, or may reduce power consumption. The processors 118, 170 may schedule the wireless interfaces 115, 165 to switch between the sleep mode and the wake up mode periodically every frame time (e.g., 11 ms or 16 ms). For example, the wireless interfaces 115, 165 may operate in the wake up mode for 2 ms of the frame time, and the wireless interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the wireless interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the wireless interfaces 115, 165 to enter a subsequent wake up mode according to timing of the previous communication indicated by the stored information. For example, the wireless interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the wireless interfaces 115, 165 to resume communication via the channel or frequency band of the previous communication indicated by the stored information. Accordingly, the wireless interfaces 115, in 165 entering the wake up mode from the sleep mode may resume communication, while bypassing a scan procedure to search for available channels and/or performing handshake or authentication. Bypassing the scan procedure allows extension of a duration of the wireless interfaces 115, 165 operating in the sleep mode, such that the computing device 110 and the HWD 150 can reduce power consumption.

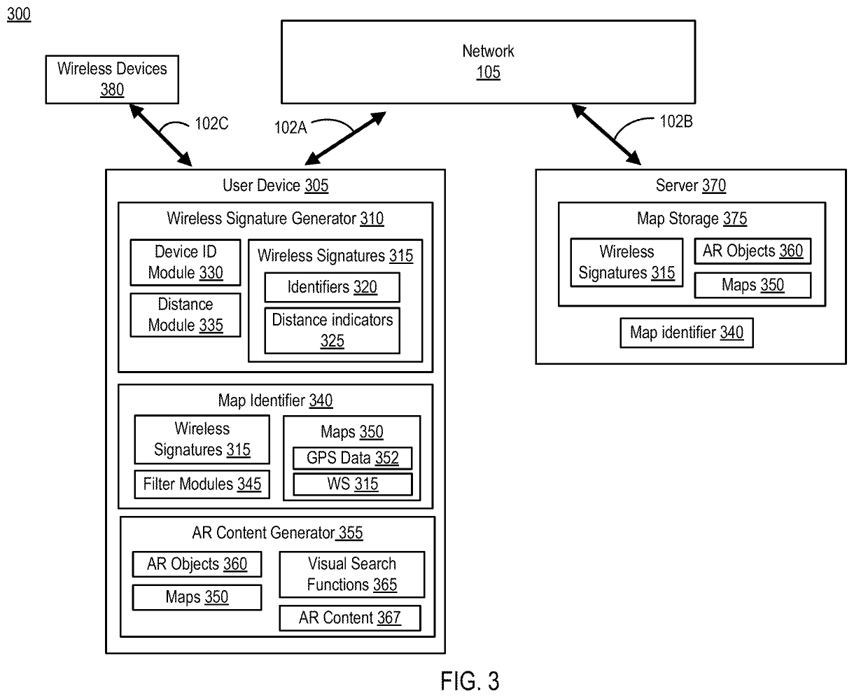

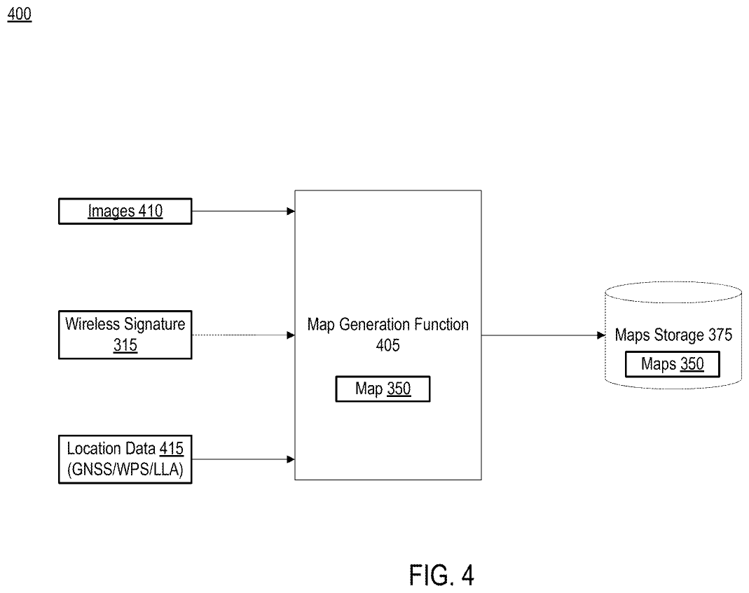

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference. Detailed descriptions on coordinating communication links of different devices are provided below with respect to FIGS. 3 and 4 below.

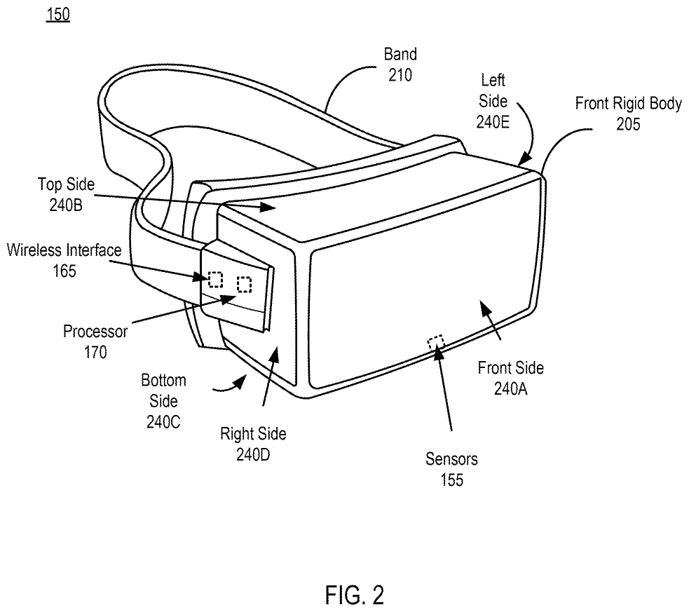

FIG. 2 is a diagram of a HWD 150, in accordance with an example embodiment. In some embodiments, the HWD 150 includes a front rigid body 205 and a band 210. The front rigid body 205 includes the display 175 (not shown in FIG. 2), the lens (not shown in FIG. 2), the sensors 155, the wireless interface 165, and the processor 170. In the embodiment shown by FIG. 2, the wireless interface 165, the processor 170, and the sensors 155 are located within the front rigid body 205, and may not visible to the user. In other embodiments, the HWD 150 has a different configuration than shown in FIG. 2. For example, the wireless interface 165, the processor 170, and/or the sensors 155 may be in different locations than shown in FIG. 2.

FIG. 3 depicts an example system 300 in which a user device 305 creates wireless signatures 315 using signals from wireless devices 380 (e.g., Wifi access point, cellular base station) while communicating with a remote server 370 via a network (e.g., including a network 105) to retrieve maps 350 for AR map generation. User device 305 can receive signals from wireless devices 380 via wireless links 102C and can communicate with a server 370, via the network 105, using links 102A and 102B. User device 305 can include and utilize a wireless signature generator (WSG) 310, a map identifier 340 and/or an AR content generator 355. WSG 310 can include a device identifier (ID) engine 330, a distance engine 335 and can include or generate a wireless signature 315 that can include one or more identifiers 320 and one or more distance indicators 325. Map identifier 340 can include or utilize one or more wireless signatures 315 along with one or more filter engines 345 to identify and retrieve one or more maps 350. Each map 350 can include GPS data 352 and/or wireless signature (WS) 315 associated with the corresponding map 350. AR content generator 355 can include/use one or more AR objects 360, maps 350 and visual search functions 365 to generate one or more AR content 367 for viewing by the user. Across the network 105, a server 370 can include a map identifier 340 and/or a map storage 375 including one or more wireless signatures 315, AR objects 360 and/or maps 350 stored for user device recovery.

At a high level, a user device 305 (e.g., a HWD 150 using or including a computing device 110A) can utilize a WSG 310 to generate wireless signatures 315 at a location of the user device 305. The generated WS 315 can be used by the user device 305 to efficiently and accurately identify maps 350 from the map storage 375 that the user device 305 can use to generate AR content 367 with embedded AR objects 360. To generate the WS 315, the WSG 310 can utilize a device ID engine 330 to acquire unique identifiers 320 of the wireless devices 380 whose signals the user device 305 can receive at the location of the user device 305 via links 102C. The wireless devices 380 can include cellular base stations, Wi-Fi routers, Bluetooth devices or any other wireless communication devices. For all the wireless devices 380 uniquely identified by identifiers 320, a distance engine 335 of the WSG 310 can determine or acquire distance indicators 325 between the user device 305 and each of the identified wireless devices 380, to produce/generate the wireless signature 315 of that user location. A map identifier 340, which can be deployed on the user device 305 and/or on a map server 370, can use the generated WS 315 along with one or more filter engines 345 to identify and retrieve maps 350 stored at the map storage 375 for AR content generation. Maps 350 to be retrieved can be identified based on a match between the generated WS 315 and the WS 315 data associated with one or more stored maps 350 at the map storage 375. When user device 305 receives the matching maps 350, AR content generator 355 can utilize visual search functions 365 to identify exact locations (e.g., on the matching maps, and/or at real physical locations/space) at which to place or render AR objects 360, thereafter generating the AR content 367 with the AR objects 360 to display on the user device 305 (e.g., HWD 150 of the user).

A user device 305 can include any device for generating wireless signatures 315 at a user location or recovering stored maps 350 of a user location in order to render or display an AR object 360 to the user device at the user location. A user device 305 can include a HWD 150 and/or a computing device 110. User device 305 can communicate with a remote server 370 to identify and access maps 350. A user device 305 can include and access maps 350 at a local map storage 375 and/or can access maps 350 via a remote map storage 375 (e.g., across network 105). User device 305 can generate wireless signatures 315 by receiving or detecting unique identifiers of the wireless devices 380 and by determining, calculating or estimating a distance between the location of the user device 305 and each of the wireless devices 380. User device 305 can include the functionality for measuring signal strength or intensity from the wireless devices 380 at the location of the user device 305 and creating a wireless signature 315 of the user location (e.g., location at which the user device 305 is located) using the measurement (as an indicator of separation distance) for instance.

Wireless signature (WS) 315, which can also be referred to as the wireless fingerprint 315, can include any combination of unique identifiers 320 of wireless devices 380 and distances (e.g., distance indicators 325) between the user device 305 and each of the detected wireless devices 380 at the user location. A wireless signature 315 can include any number of identifiers 320 of any number of wireless devices 380 that can be detected at the location of the user device 305. For example, wireless devices 380 can include any devices emitting a wireless signal, including devices sending wireless signal in the Wi-Fi, Bluetooth, cellular, 3G, 4G LTE, 5G, global positioning system (GPS) data, global navigation satellite system (GNSS) data or any other wireless communication protocol.

Distance indicators 325 of the WS 315 at a specific location of the user device can include a representation of a distance between the user device 305 at that location and each of the wireless devices 380 detected at that location. Distance indicators 325 can include any measure, estimate or determination of a distance, such as a number of feet or meters of distance between the user device 305 and the wireless device 380. Distance indicators 325 can be represented using any unit of distance (e.g., meters, feet, centimeter, mile) and via any coordinates, such as, for example Cartesian coordinates, polar coordinates, cylindrical coordinates and others. The user location (e.g., the location at which the wireless signature 315 is established or determined) can include any area, such as a point location (e.g., a corner of a building), or a space or an area, such as a room of an apartment building, a conference room or a hallway of a building, a parking space, a park area, a garden area, a portion of an arena, a mountain, a river bank, a city block, a house or any other location that can be used for mapping and display of an AR object 360 via the user device 305.

Wireless signature 315 can be represented in any number of ways. For example, a WS 315 can include a combination of identifiers 320 and distance indicators 325 in a data structure, a table, a file or a compilation of values. Wireless signature 315 can include or be represented by a vector of 2-tuples. The vector 2-tuple can include one or more identifiers 320 and one or more distance indicators 320. Wireless signature 315 can include a matrix or multiple matrices. The matrix or matrices can include one or more identifiers 320 and distance indicators 325 corresponding to each of the wireless devices 380 detected at the given user location. Wireless signature 315 can correspond to each individual user location, or one or more locations that can pertain to a map 350.

A wireless signature generator 310, also referred to as the WSG 310, can include any combination of hardware and software for generating wireless signatures 315. WSG 310 can include any combination of circuitry, processors, functions, controllers, antennas, modems, computer code, and instructions to receive, acquire, detect, measure or determine identifiers 320 and distance indicators 325 of the wireless signature 315. WSG 310 can make or generate any number of readings pertaining to wireless devices 380 and distances between the wireless devices 380. WSG 310 can make measurements of signals (e.g., determine distance indicators data) and acquire data (e.g., detect identifiers 320) at any location in an area corresponding to a particular map 350 at which user device 305 can be located, such as for example a location within a room, a floor of a building, a structure, a city block, a park or any other location.

WSG 310 can include a device ID engine 330 which can include any functionality for acquiring, detecting, determining and storing any type of identifiers 320 of a wireless device 380. Device ID engine 330 can acquire unique identifiers for any wireless device 380, such as a Wi-Fi wireless device, a Bluetooth wireless device, a cellular wireless device or any other device emitting or receiving a wireless signal. For example, when a wireless device 380 is a Wi-Fi, WSG 310 can utilize an ID engine 330 to receive, detect and store a service set identifier (SSID) or a basic service set identifier (BSSID) of the Wi-Fi device, or any other identifier of a Wi-Fi device. For example, when a wireless device 380 is a Bluetooth device, WSG 310 can utilize an ID engine 330 to receive, detect and store a Bluetooth device address (BD_ADDR), which can include a 12-digit hexadecimal value set identifier, an internet protocol (IP) address of the Bluetooth device, or any other Bluetooth identifier. For example, when a wireless device 380 is a cellular device, WSG 310 can utilize an ID engine 330 to receive, detect and store a base station identity code (BSIC), a global system for mobile communications cell identifier (GSM cell ID), a physical cell identity (PCI), or any other unique identifier of a cellular wireless device 380.

Distance engine 335 can include any combination of circuitry, processors, logic, instructions, commands or computer code for determining or calculating a distance, range or separation between user device 305 and any wireless device 380. Distance engine 335 can include functionality for receiving signals from any type and form of wireless devices 380, determining the characteristics of the signal (e.g., distance, strength, intensity, location) and determining from the characteristic the distance between the user device 305 and the wireless device 380. For example, a distance engine 335 can utilize a signal from a wireless device 380, such as a Bluetooth, a Wi-Fi or a cellular device, to determine the distance between the wireless device 380 and the user device 305. Distance engine 335 can utilize multiple data readings from the wireless device 380 to filter (e.g., suppress, average out, apply certain weights on, or exclude) any outlier data and can measure or identify an average signal strength value at a particular location. Based on the measured or identified value, the distance model 335 can determine a distance (e.g., Euclidean distance) between the user device 305 and the wireless device 380. Distance engine 335 can include functionality for taking measurements of the wireless device 380 signal, filtering measured data, smoothing or averaging the data and determining a value of the distance from the wireless signal strength or wireless data.

Map identifier 340 can include any combination of hardware and software to identify, select and/or retrieve maps 350. Map identifier 340 include the functionality to compare a WS 315 generated by the WSG 310 with any number of WSs 315 associated with any number of maps 350 stored at map storage 375. Map identifier 340 can include the functionality to identify a match between the WS 315 generated at the user location and one or more WSs 315 associated with one or more maps 350 at the map storage 375. Map identifier 340 can include the functionality to communicate with a map server 370 over a network 105 or execute on a remote server 370 and access the map storage 375 locally or remotely. In an implementation in which map identifier 340 is executed on a remote map server 370, user device 305 can send the wireless signature 315 generated by the WSG 310 to the map server 370 and the map server 370 can utilize the generated WS 315 to identify the relevant one or more maps 350 by matching the generated WS 315 with WSs 315 associated with the maps.

Filter engines 345 can include functions for identifying the maps 350 to utilize for processing by the user device 305. Filter engines 345 can include filtering functions to filter out the maps 350 with (e.g., corresponding to) WSs 315 that do not match the generated WS 315. Filter engines 345 can include GPS data filter that can filter out maps 330 whose GPS data does not match the GPS data of the user location. For example, filter engines 345 can utilize a filter that identifies maps 350 whose latitude, longitude, and altitude are within a threshold range of the user location. For example, filter engine 345 that filters maps 350 based on latitude, longitude and altitude (LLA) can be referred to as the LLA filters 345. Filter engines 345 can include wireless signature filter or a wireless fingerprint filter which can filter out all maps 350 with WSs 315 that do not match with the WS 315 that is generated at the user location. For example, a wireless signature filter 345 can identify only the maps 350 with WSs 315 that match the generated WS 315 within a predetermined tolerance or threshold range. The tolerance or a threshold range can include, for example, the maps 350 with identifiers 320 of wireless devices 380 in their corresponding WS 315 of the maps 350 match the identifiers 320 of the WS 315 generated at the user location. The tolerance or a threshold range can include, for example, the maps 350 with identifiers 320 that match that of the generated WS 315, and whose distance indicators 325 match those of the generated WS 315 to within a tolerance range, such as for example within 5%, 10%, 15%, 20%, 30%, 50%, 70%, 90%, 95% or more than 95% of the distance values.

Maps 350, also referred to as extended or augmented or artificial reality maps 350 (sometimes referred to in this disclosure as AR maps 350 by way of illustration), can include any combination of data for generating a location displayed by the user device 305. Maps 350 can be used for generating AR content 367 and can be referred to augmented reality maps 350. For example, maps 350 can include maps, geographic data, images, videos or any data for illustrating or depicting to the user, via the user device 305, at least a portion of a city, a town, a forest, a mountain, a park, a riverside, a beach, an island, a street center, a city block, a building structure, a floor inside of a building, an apartment in a building, one or more rooms surrounding a room in which the user is located, the room or an area in which the user is located, or any portion or a room or an area that is visible from the user's location. Maps 350 can include geographic maps, topographical features, structural features, environmental features, dimensions, two and/or three dimensional information, boundaries and/or images. Maps 350, or AR maps 350, can include three dimensional drawings of structures, such as the exterior or interior of building structures or areas. Maps 350 can include or be associated with one or more wireless signatures 315, Wi-Fi Protected Setup (WPS) data, and GPS data, such as LLA data or GNSS data. Maps 350 can include or be associated with one or more GPS data, such as LLA data.

AR content generator 355 can include any combination of hardware and software to generate AR data to the user device 305 using maps 350. AR content generator 355 can utilize maps 350 identified by the map identifier 340 and visual search functions 365 to identify specific location (e.g., surface, region, object, feature, point) at which to place or render the AR object 360. The AR object 360 can be any object to be displayed at the intended location, such as for example a vase on a desk of an office, a picture on a wall, a display on a table, a rug on the floor, an artificial figure at a location in a room, or any other AR object 360 to be inserted into live image(s) matched with maps 350 identified using the user device 305 generated wireless signature 315, and/or to be inserted into AR content 367 to be generated/retrieved by the AR map generator using the maps 350 identified using the user device 305 generated wireless signature 315.

Visual search functions 365 can include any functionality for identifying a location within a map 350 at which to render the AR object 360. Visual search function 365 can include the functionality for scanning and recognizing different portions of a map 350 matching the WS 315 most closely to identify the specific location at which to place or render the AR object 360.

Server 370 can include a combination of hardware and software for storing maps 350 and providing maps 350 to user devices 305. Server 370 can include processors, memory, circuitry, computer code and instructions for receiving a WS 315 from a user device 305, can identify the map 350 (e.g., such as by executing map identifier 340 with filter engines 345 on the server 370) and can select matching maps 350 for the user device 305. The map storage 375 can include any storage device storing maps 350, either in storage structures, database or any other format provided by the map storage 375. Map storage 375 can include a data structure, such as a table, that provides WSs 315 of each of the stored maps 350 so that the WS 315 generated by the user device 305 can be used as an index to identify one or more most closely matching WSs 315, and in doing so identify most suitable/relevant maps 350 to retrieve and provide to the user device 305 for processing.

FIG. 4 depicts an example of a system 400 for generating maps 350 for maps storage 375. System 400 can include a map generation function 405, configured to receive images 410, wireless signature 315 and/or location data 415 (e.g., GNSS, WPS or LLA data) to generate a map 350. A map 350 (e.g., an augmented reality map) can include a combination of images 410, drawn artificial (e.g., virtual) features and one or more AR objects 360. Once the map 350 is generated, the map generation function 405 can send the map 350 to a maps storage 375 in which maps 350 are stored.

Map generation function 405 can include any combination of hardware and software for generating a map 350 and can be deployed on a user device 305. Map generation function 405 can include circuitry, processors, instructions and computer code for combining images 410, WSs 315 and/or location data 415 into a map 350. Map generation function 405 can receive images 410, such as photographic images, video data or generated (e.g., CAD) data or files. Map generation function 405 can receive WS 315 from a user device 305 as the user device generates the WS 315 for a particular user location. Map generation function 405 can receive location data 415 of the user location at which the WS 315 is generated, such as GNSS data, GPS data, LLA data, or WPS data pertaining to the user location. Map generation function 405 can generate the map 350 and can associate or link the WS 315 and/or location data 415 to the map 350. Map generation function 405 can transmit the map 350 to the maps storage 375 to store the map 350 among other maps 350. Maps storage 375 can include a database, data structure or a function that can correspond the WS 315 and location data 415 with each of the maps 350 generated, so that it can be searched by the map identifier 340 per request by user device 305.

In some aspects, the present disclosure relates to a system 300 that can include a user device 305 that can include at least one processor (e.g., 118 or 170). The processor can be configured establish a wireless signature 315 for a location of the user device 305. The WS 315 can represent one or more unique identifiers 320 of one or more wireless communication devices 380 and one or more distance indicators 325 of the one or more wireless communication devices 380 relative to the user device 305. The processor (e.g., 118 or 170) can be configured to identify one or more augmented reality maps 350 from a plurality of augmented reality maps 350 according to the wireless signature 315. The processor (e.g., 118 or 170) can identify a first augmented reality map 350 of the one or more augmented reality maps 350 associated with the location of the user device 305 to render an artificial reality object 360 corresponding to the first augmented reality map 350.

The one or more wireless communication devices 380 can include a plurality of wireless communication devices 380 configured to communicate according to one or more wireless communication protocols. The one or more wireless communication devices 380 can be configured to communicate according to at least one of: a Bluetooth-based communication protocol, a wireless local area network (WLAN) communication protocol or a cellular communication protocol.

The device 305 (e.g., user device 305) can be configured to determine a first distance indicator 325 of the one or more distance indicators 325 between the device 305 and a first wireless communication device 380 of the one or more wireless communication devices 380 according to a plurality of measurements of signals from the first wireless communication device performed by the device 305 over a period of time. For example, a user device 305 can utilize a distance engine 335 to determine distances and relative locations of the wireless devices 380 relative to the user device 305 location or determine the user device 305 location with respect the relative devices 380. The user device 305 can receive signals from the wireless device 380 for a period of time, such as up to 10 milliseconds, 50 milliseconds, 100 milliseconds, 500 milliseconds or a second. Distance engine 335 can remove all the outlier data measurements and/or can determine an average value of the readings over the period of time. Based on the average value, the distance engine 335 can determine the distance between the locations of the user device 305 and the wireless device 380.

The user device 305 can be configured to identify using the wireless signature 315 of the location of the device 305, the one or more augmented reality maps 350 from a plurality of augmented reality maps 350. The plurality of augmented reality maps 350 can each be associated with at least one wireless signature 315. The user device 305 can be further configured to identify the one or more augmented reality maps 350 from a subset of a plurality of augmented reality maps 350. The subset of the plurality of augmented reality maps 350 can be identified using at least one of: latitude information, longitude information or altitude information of the device 305. The user device 305 can be configured to generate at a first location a first augmented reality map 350 and a first wireless signature 315 corresponding to the first augmented reality map 350. The user device 305 can be configured to provide, to a storage 375, at least one of: the first augmented reality map 350, the first wireless signature 315 or positioning information of the user device 305 at the first location, for storage.

In some aspects, the present solution relates to a non-transitory computer readable medium storing program instructions for causing at least one processor (e.g., 118 or 170) of a device 305 to establish a wireless signature 315 for a location of the device 305. The wireless signature 305 representing one or more unique identifiers 320 of one or more wireless communication devices 380 and one or more distance indicators 325 of the one or more wireless communication devices 380 relative to the device 305. The program instructions can cause at least one processor (e.g., 118 or 170) of a device 305 to identify one or more augmented reality maps 350 from a plurality of augmented reality maps 350 according to the wireless signature 315. The program instructions can cause at least one processor (e.g., 118 or 170) of a device 305 to identify a first augmented reality map 350 of the one or more augmented reality maps 350 associated with the location of the device 305 to render an artificial reality object 360 corresponding to the first augmented reality map 350.

Each of the one or more wireless communication devices 380 can be configured to communicate according to at least one of: a Bluetooth-based communication protocol, a wireless local area network (WLAN) communication protocol or a cellular communication protocol. The program instructions can cause the at least one processor (e.g., 118 or 170) to determine a first distance indicator 325 of the one or more distance indicators 325 between the device 305 and a first wireless communication device 380 of the one or more wireless communication devices 380 according to a plurality of measurements of signals from the first wireless communication device 380 performed by the device over a period of time.

The program instructions can cause the processor (e.g., 118 or 170) to identify, using the wireless signature 315 of the location of the device 305, the one or more augmented reality maps 350 from a plurality of augmented reality maps 350. The plurality of augmented reality maps 350 can each be associated with at least one wireless signature 315. The program instructions can cause the processor (e.g., 118 or 170) to identify the one or more augmented reality maps 350 from a subset of the plurality of augmented reality maps 350. The subset of the plurality of augmented reality maps 350 can be identified using one or more of location data 415, such as latitude information, longitude information or altitude information or data of the device 305.

The program instructions can cause the processor (e.g., 118 or 170) to generate at a first location a first augmented reality map 350 and a first wireless signature 315 corresponding to the first augmented reality map. The program instructions can cause the processor (e.g., 118 or 170) to provide, to a map storage 375, at least one of: the first augmented reality map 350, the first wireless signature 315, or positioning information of the device at the first location, for storage. The positioning information can include any information derived from the distance indicators 325 and the user location of the user device 305.

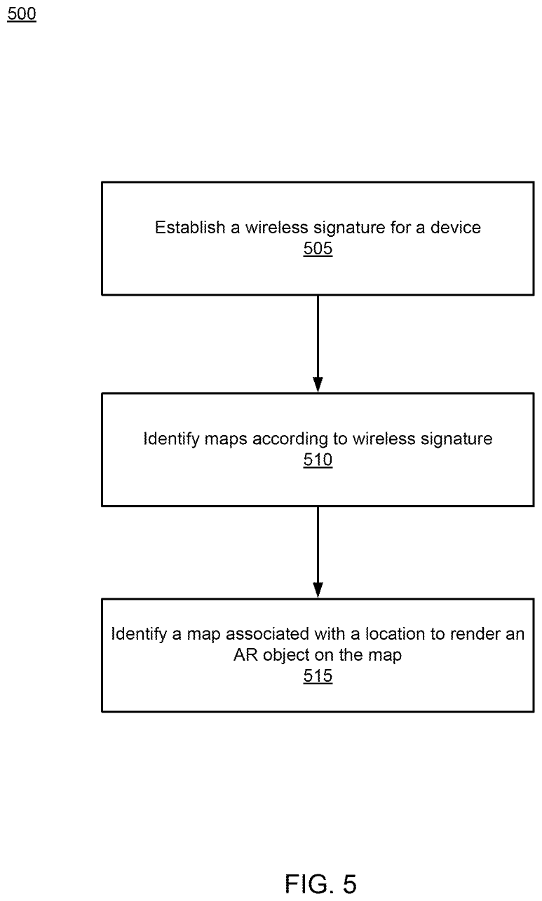

FIG. 5 illustrates an example flowchart of a method 500 of using a generated wireless signature to identify augmented reality map for rendering an AR object for a user device. Method 500 can include ACTS 505-515. The method 500 can be performed, for example, by any one or more of the components of the system illustrated and discussed in connection with FIGS. 3-4. At ACT 505, the method establishes a wireless signature for a device. At ACT 510, the method identifies maps according to wireless signature. At ACT 515, the method identifies a map associated with a location to render an AR object on the map.

At ACT 505, the method establishes a wireless signature for a device. The method can include establishing, by a device, a wireless signature for a location of the device. The wireless signature can represent one or more unique identifiers of one or more wireless communication devices and one or more distance indicators of the one or more wireless communication devices relative to the device. The one or more wireless communication devices can include a plurality of wireless communication devices configured to communicate according to one or more wireless communication protocols. Each of the one or more wireless communication devices can be configured to communicate according to at least one of: a Bluetooth-based communication protocol, a wireless local area network (WLAN) communication protocol or a cellular communication protocol.

The method can include determining, by a user device, a first distance indicator of the one or more distance indicators, between the device and a first wireless communication device of the one or more wireless communication devices. The first distance can be determined according to a plurality of measurements of signals (e.g., signal strength/intensity, signal travel time) from the first wireless communication device performed by the device over a period of time. The user device can obtain an indication of a unique identifier of a wireless communication devices, by receiving or intercepting a communication (e.g., a beacon or discovery signal) of the wireless communication devices. The device can establish/generate a wireless signature for the location of the device by for example, linking, combining, appending, and/or encoding the unique identifier of each wireless communication device and a distance indicator corresponding to the respective wireless communication device.

At ACT 510, the method identifies maps according to wireless signature. The method can include identifying, by the device, one or more augmented reality maps from a plurality of augmented reality maps, according to the wireless signature. The method can identify, by the device using the wireless signature of the location of the device, the one or more augmented reality maps from a plurality of augmented reality maps, that are possible candidates relevant to the location of the device. The plurality of augmented reality maps can each be associated with at least one wireless signature (which may or may not include the wireless signature established by the device). In one embodiment, the method can include identifying, by the device according to the wireless signature, the one or more augmented reality maps from a subset of a plurality of augmented reality maps. The device can determine/identify the subset from the plurality of augmented reality maps using at least one of latitude information, longitude information or altitude information of the device (e.g., via a LLA filtering process).

At ACT 515, the method identifies a map associated with a location. The method can include identifying, by the device, a first augmented reality map of the one or more augmented reality maps associated with the location of the device, to render an artificial reality object corresponding to the first augmented reality map. For example, the device may use image(s) and/or information (e.g., topological/topographical/depth/distance information corresponding to one or more local features) acquired by the device at the location, to compare against the one or more augmented reality maps, to identify a map with matching feature(s) at the location. The device may use the identified map to access/generate an augmented reality object (e.g., corresponding to the identified map and/or the location) to render/present to a user of the device (e.g., corresponding to the orientation/direction of the device at the location).

In some embodiments, the method can include generating, by the device at a first location, a first augmented reality map and a first wireless signature corresponding to the first augmented reality map. The method can include providing, by the device to a storage, at least one of: the first augmented reality map, the first wireless signature, or positioning information of the device at the first location, for storage (e.g., which can be retrieved for use when preparing to render an XR object at the same location).

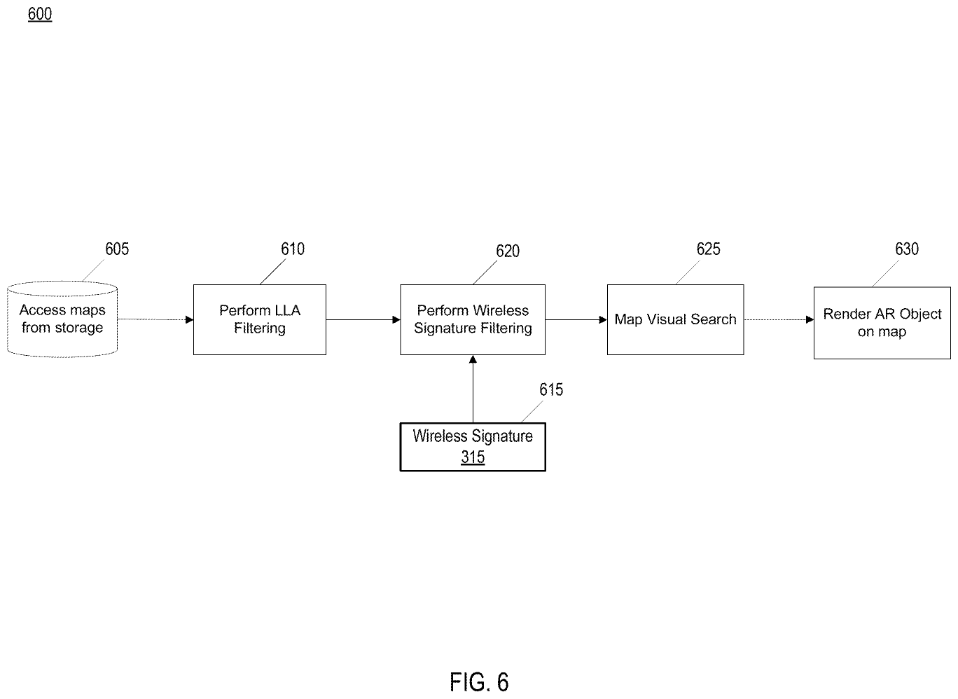

FIG. 6 illustrates an example flowchart of a method 600 of using a generated wireless signature to identify an augmented reality map for rendering an AR object for a user device. Method 600 can include ACTS 605-630. The method 600 can be performed, for example, by one or more components of the system illustrated and discussed in connection with FIGS. 3-4. At ACT 605, the method accesses maps from storage. At ACT 610, the method performs LLA filtering. At ACT 615, the method provides a wireless signature. At ACT 620, the method performs wireless signature filtering. At ACT 625 the method performs visual search. At ACT 630 the method renders an AR object on a map.

At ACT 605, the method accesses maps from storage. The method can include accessing, by a user device, maps from storage. The user device can connect or gain access to a storage map storing a plurality of maps. The maps can include all the maps of all regions or areas that the system can provide or display on a user's heads up display device. The maps can be provided by a map storage on a remote server. The maps can be provided by a map storage on the user device or in communication with the user device.

At ACT 610, the method performs LLA (e.g., latitude, longitude and altitude) filtering. The method can include using location data, such as latitude, longitude and altitude data of a user device to compare maps with the LLA filter one or more maps stored at the storage for the maps. The method can include receiving location data, such as GPS, GNSS or LLA data from a user device at the user location and use such data to compare the location data of the user device against the location data of the maps stored in the storage. The method can, by comparison and matching, identify maps among the plurality of maps stored in the storage that match the location data of the user. Upon identifying the matching subset of AR maps from the plurality of AR maps, based on the LLA, GNSS, GPS or other location data, the method can forward the subset of identified AR maps to the next step for wireless signature comparison.

At ACT 615, the method provides a wireless signature. The method can include generating, by the user device, the wireless signature at the wireless location. The user device can utilize a device ID engine to identify unique identifiers of the wireless devices whose signal covers the location of the user device. The user device can utilize a distance engine to determine the distance between each of the identified wireless devices and the location of the user device. The user device can utilize wireless signature generator to generate the wireless signature of the user device at the user location using the identified unique identifiers of the wireless devices and the distance indicators corresponding to each of the wireless devices

At ACT 620, the method performs wireless signature filtering. The method can use the wireless signature generated by the user device at the user location to match against wireless signatures corresponding to the plurality of maps stored at the storage. The method can identify a subset of maps that include corresponding wireless signatures that match the wireless signature of the user device at the user location. Based on the matching of the wireless signatures of the subset of AR maps at the storage with the wireless signature of the user device generated at the user location, the method can identify one or more AR maps that match the wireless signature data and the location data of the user device.

At ACT 625 the method performs visual search. The method an include utilizing visual search functions to perform visual searching of the one or more selected maps from the ACT 620 to determine or identify locations at which to render an AR object. The user device can utilize an AR content generator to identify the location at one of the maps selected at ACT 620 at which to place the AR object.

At ACT 630 the method renders an AR object on a map. The method can include rendering the AR object at a location of the map. The location of the map can be the location identified by the visual search function. The present solution can render the AR object at the location identified by the map visual search at ACT 625.

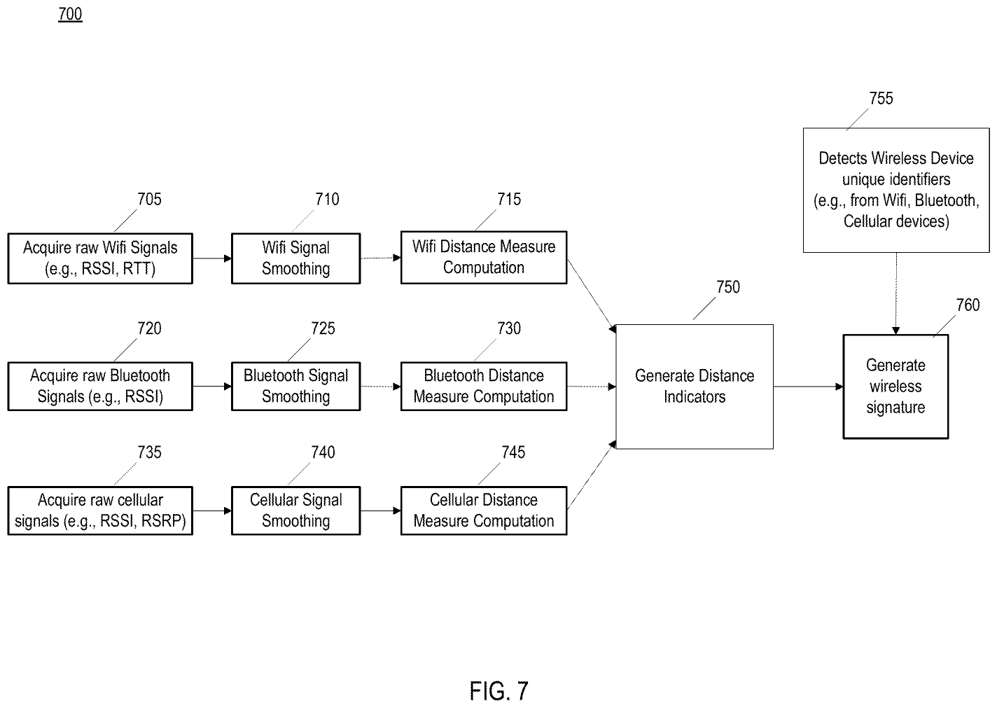

FIG. 7 illustrates an example flowchart of a method 700 of using a generating a wireless signature (e.g., wireless fingerprint). Method 700 can include ACTS 705-760. The method 700 can be performed, for example, by a user device, such as those in the examples that are illustrated and discussed in connection with FIGS. 3-4. At ACT 705, the method acquires raw Wi-Fi signals. At ACT 710, the method performs Wi-Fi signal smoothing. At ACT 715, the method performs Wi-Fi distance measure computation. At ACT 720, the method acquires raw Bluetooth signals. At ACT 725, the method performs Bluetooth signal smoothing. At ACT 730, the method performs Bluetooth distance measure computation. At ACT 735, the method acquires raw cellular signals. At ACT 740, the method performs cellular signal smoothing. At ACT 745, the method performs cellular distance measure computation. At ACT 750, the method generates distance indicators 750. At ACT 755, the method detects wireless device unique identifiers. At ACT 760, the method generates the wireless signature.

At ACT 705, the method can acquire raw Wi-Fi signals. The raw Wi-Fi signals can include RSSI, real time text (RTT) or any other Wi-Fi signal or transmission. At ACT 710, the method can perform or implement Wi-Fi signal smoothing. The Wi-Fi signal smoothing can include removing outlier data and averaging a plurality of measurements over a time period in order to determine the average or median value. At ACT 715, the method can perform Wi-Fi distance measure computation. The Wi-Fi distance measure computation can be implemented by analyzing signal intensity or reading signal information. The resulting Wi-Fi distance measure results can be fed into the function at ACT 750.

At ACT 720, the method acquires raw Bluetooth signals. The raw Bluetooth signals can include RSSI signals or any other Bluetooth signal or transmission. At ACT 725, the method can performs Bluetooth signal smoothing, which can include removing outlier data (e.g., values that far exceed other similar values) and an average result of the data measurements can be determined. At ACT 730, the method can perform Bluetooth distance measure computation. The Bluetooth distance measure computation can include analysis of Bluetooth signals and determining the distance based on the signal intensity at the user location. The resulting Bluetooth distance measured results can be fed into the function at ACT 750.

At ACT 735, the method can acquire raw cellular signals. The raw cellular signals can include RSSI or reference signal received power (RSRP) transmissions. At ACT 740, the method can perform cellular signal smoothing. The cellular signal smoothing can include removing outlier data and taking the average or a median of the remaining data. At ACT 745, the method can perform cellular distance measure computation. The cellular distance measure computation can include using the average or median (e.g., smoothed) data to determine the distance between the cell location and the user location. The resulting cellular distance measured results can be fed into the function at ACT 750.

At ACT 750, the method can generate distance indicators 750. The method can utilize Wi-Fi distance measurement results from ACT 715, Bluetooth distance measurement results from ACT 730 and cellular distance measurement results from ACT 745 to determine, calculate or generate distance indicators for the wireless signature.

At ACT 755, the method can detect wireless device unique identifiers. Wireless device unique identifiers can include any unique identifiers from Wi-Fi, Bluetooth, cellular or any other devices. For example, unique identifiers can include an SSID or a BSSID of a Wi-Fi device BD_ADDR or an IP address of a Bluetooth device, an IP address or a MAC address of a router, a BSIC, a GSM cell ID, or a PCI of a cellular wireless device 380.

At ACT 760, the method can generate the wireless signature. The wireless signature can be generated by combining distance indicators from ACT 750 with unique identifiers from ACT 755. The wireless signature can be expressed or arranged as a 2-tuple comprising the unique identifiers and the distance indicators for each of the wireless communication devices. The wireless signature can be expressed as one or more matrices, files, executables or entries in a database that can be used to identify artificial reality maps.

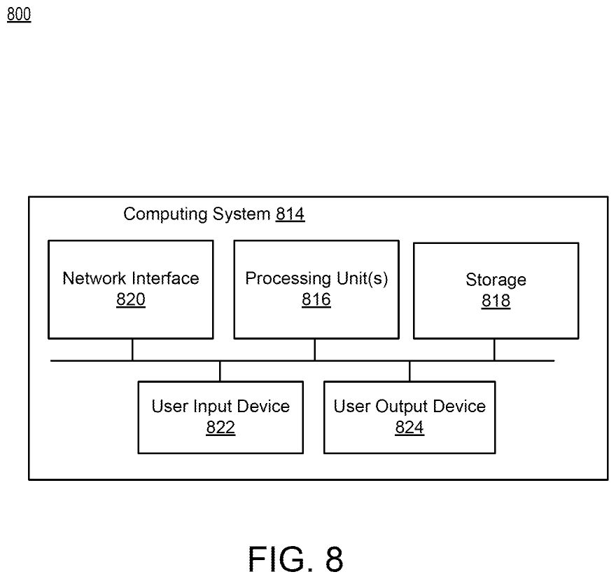

Various operations described herein can be implemented on computer systems. FIG. 8 shows an example block diagram 800 of a representative computing system 814 usable to implement the present disclosure. In some embodiments, example systems, such as the systems 100, 200, 300, 400 and the HWD 150 of FIGS. 1-4 can be implemented on or using the computing system 814. Computing system 814 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 814 can be implemented to provide VR, AR, MR experience. In some embodiments, the computing system 814 can include conventional computer components such as processors 816, storage device 818, network interface 820, user input device 822, and user output device 824.

Network interface 820 can provide a connection to a wide area network (e.g., the Internet) to which WAN interface of a remote server system is also connected. Network interface 820 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 822 can include any device (or devices) via which a user can provide signals to computing system 814; computing system 814 can interpret the signals as indicative of particular user requests or information. User input device 822 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 824 can include any device via which computing system 814 can provide information to a user. For example, user output device 824 can include a display to display images generated by or delivered to computing system 814. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 824 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 816 can provide various functionality for computing system 814, including any of the functionality described herein as being performed by a server or client, or other functionality associated with message management services.

It will be appreciated that computing system 814 is illustrative and that variations and modifications are possible. Computer systems used in connection with the present disclosure can have other capabilities not specifically described here. Further, while computing system 814 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
establishing, by a device, a wireless signature for a location of the device, the wireless signature representing one or more unique identifiers of one or more wireless communication devices and one or more distance indicators of the one or more wireless communication devices relative to the device;
identifying, by the device, one or more augmented reality maps from a plurality of augmented reality maps according to the wireless signature; and
identifying, by the device, a first augmented reality map of the one or more augmented reality maps associated with the location of the device, to render an artificial reality object corresponding to the first augmented reality map.

2. The method of claim 1, wherein the one or more wireless communication devices include a plurality of wireless communication devices configured to communicate according to one or more wireless communication protocols.

3. The method of claim 1, wherein each of the one or more wireless communication devices is configured to communicate according to at least one of: a Bluetooth-based communication protocol, a wireless local area network (WLAN) communication protocol or a cellular communication protocol.

4. The method of claim 1, comprising:
determining, by the device, a first distance indicator of the one or more distance indicators, between the device and a first wireless communication device of the one or more wireless communication devices, according to a plurality of measurements of signals from the first wireless communication device performed by the device over a period of time.

5. The method of claim 1, comprising:
identifying, by the device using the wireless signature of the location of the device, the one or more augmented reality maps from the plurality of augmented reality maps, the plurality of augmented reality maps each associated with at least one wireless signature.

6. The method of claim 1, comprising:
identifying, by the device, the one or more augmented reality maps from a subset of a plurality of augmented reality maps, the subset of the plurality of augmented reality maps identified using at least one of: latitude information, longitude information or altitude information of the device.

7. The method of claim 1, comprising:
generating, by the device at a first location, a first augmented reality map and a first wireless signature corresponding to the first augmented reality map; and
providing, by the device to a storage, at least one of: the first augmented reality map, the first wireless signature, or positioning information of the device at the first location, for storage.

8. A system comprising:
a device comprising at least one processor, configured to:
establish a wireless signature for a location of the device, the wireless signature representing one or more unique identifiers of one or more wireless communication devices and one or more distance indicators of the one or more wireless communication devices relative to the device;
identify one or more augmented reality maps from a plurality of augmented reality maps according to the wireless signature; and
identify a first augmented reality map of the one or more augmented reality maps associated with the location of the device, to render an artificial reality object corresponding to the first augmented reality map.

9. The system of claim 8, wherein the one or more wireless communication devices include a plurality of wireless communication devices configured to communicate according to one or more wireless communication protocols.

10. The system of claim 8, wherein the one or more wireless communication devices is configured to communicate according to at least one of: a Bluetooth-based communication protocol, a wireless local area network (WLAN) communication protocol or a cellular communication protocol.

11. The system of claim 8, wherein the device is further configured to determine a first distance indicator of the one or more distance indicators between the device and a first wireless communication device of the one or more wireless communication devices according to a plurality of measurements of signals from the first wireless communication device performed by the device over a period of time.

12. The system of claim 8, wherein the device is further configured to:
identify using the wireless signature of the location of the device, the one or more augmented reality maps from the plurality of augmented reality maps, the plurality of augmented reality maps each associated with at least one wireless signature.

13. The system of claim 8, wherein the device is further configured to identify the one or more augmented reality maps from a subset of a plurality of augmented reality maps, the subset of the plurality of augmented reality maps identified using at least one of: latitude information, longitude information or altitude information of the device.

14. The system of claim 8, wherein the device is further configured to:
generate at a first location a first augmented reality map and a first wireless signature corresponding to the first augmented reality map; and
provide, to a storage, at least one of: the first augmented reality map, the first wireless signature or positioning information of the device at the first location, for storage.

15. A non-transitory computer readable medium storing program instructions for causing at least one processor of a device to:
establish a wireless signature for a location of the device, the wireless signature representing one or more unique identifiers of one or more wireless communication devices and one or more distance indicators of the one or more wireless communication devices relative to the device;
identify one or more augmented reality maps from a plurality of augmented reality maps according to the wireless signature; and
identify a first augmented reality map of the one or more augmented reality maps associated with the location of the device, to render an artificial reality object corresponding to the first augmented reality map.

16. The non-transitory computer readable medium of claim 15, wherein each of the one or more wireless communication devices are configured to communicate according to at least one of: a Bluetooth-based communication protocol, a wireless local area network (WLAN) communication protocol or a cellular communication protocol.

17. The non-transitory computer readable medium of claim 15, wherein the program instructions cause the at least one processor to:
determine a first distance indicator of the one or more distance indicators between the device and a first wireless communication device of the one or more wireless communication devices according to a plurality of measurements of signals from the first wireless communication device performed by the device over a period of time.

18. The non-transitory computer readable medium of claim 15, wherein the program instructions cause the at least one processor to:
identify using the wireless signature of the location of the device the one or more augmented reality maps from the plurality of augmented reality maps, the plurality of augmented reality maps each associated with at least one wireless signature.

19. The non-transitory computer readable medium of claim 15, wherein the program instructions cause the at least one processor to:
identify the one or more augmented reality maps from a subset of the plurality of augmented reality maps, the subset of the plurality of augmented reality maps identified using at least one of: latitude information, longitude information or altitude information of the device.

20. The non-transitory computer readable medium of claim 15, wherein the program instructions cause the at least one processor to:
generate at a first location a first augmented reality map and a first wireless signature corresponding to the first augmented reality map; and
provide, to a storage, at least one of: the first augmented reality map, the first wireless signature, or positioning information of the device at the first location, for storage.
